(19) United States
(12) Patent Application Publication
(10) Pub. No.: US 2010/0318312 A1
(43) Pub. Date: Dec. 16, 2010

(54) SIMPLIFYING DETERMINATION OF WHETHER A DISPLAY CONTROLLER PROVIDES VIDEO OUTPUT WITH DESIRED QUALITY

(75) Inventors: Himanshu Jagadish Bhat, Pune (IN); Hareshkumar Gopal Borse, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/483,510

(22) Filed: Jun. 12, 2009

(51) Int. Cl. G06F 19/00

(52) U.S. Cl. 702/108

(57) ABSTRACT

An aspect of the present invention enables a tester (person) to specify multiple test cases of interest to test a display controller, and executes the test cases in a batch mode to cause the display controller to generate corresponding video output. The tester is provided the ability to specify whether the displayed video output corresponding to each executed test case is of desired quality or not. Due to such a combination of features, testing of the display controller may be simplified, efficient and reliable as well.

### BACKGROUND

1. Technical Field

The present disclosure relates to display controllers and more specifically to simplifying determination of whether a display controller provides video output with desired quality.

2. Related Art

A display controller refers to a component which generates display signals causing images to be rendered on a display unit. In a common scenario, an image frame is generated first and display signals are generated based on a present image frame to be rendered on the display unit. The images thus rendered are referred to as a video output and the display signals may be referred to as video signals (e.g., in RGB format).

It is often desirable to determine whether a display controller provides video output with a desired quality. Quality is generally measured by the acceptability of the video output to the human eye and/or how closely the actual video output on a display unit resembles an ideal video output that could be generated based on the image frames sought to be rendered.

In one prior approach (referred to as “manual testing”), a tester (testing person) uses the same graphical user interface (GUI) as that would be used by a normal (non-test, general intended use) user to set various display attributes and then executes the corresponding test case (intended to test the effect of the set attributes, typically). The tester then sets the attributes for the next test case and executes the next test case. The test cases are thus sequentially executed.

One problem with such an approach is that testing is generally tedious as the tester is typically required to navigate several GUI screens since the attributes may be available in different screens (usually for “user-friendliness’ for normal users). Completion of tests may take substantial time for the additional reason that all the tasks (providing the values for the display attributes and execution thereafter) related to a test case are to be completed before the next test case is started.

In another prior approach which overcomes some of the disadvantages noted above (referred to as “automated testing”), a set of reference image frames corresponding to an ideal output are first extracted and stored in a memory. The values of display attributes are pre-specified and stored in a memory, and the test cases are executed based on such stored values. The resulting image frames are automatically compared against the reference video images on a pixel-by-pixel basis. The image quality is concluded to be acceptable if sufficient number of pixels are found to be matching.

This alternative approach may lead to test cases being regarded as having failed (due to a number of mismatches in the pixel-by-pixel comparison), whereas the deviations from the ideal output may not be perceptible (or in general, be acceptable) to the human eye. Accordingly, several test cases may be unnecessarily concluded to be a failure, while the corresponding video output would have been acceptable in several situations.

There is accordingly a general need to provide an approach to determine whether a display controller provides video output with desired quality, while addressing one or more requirements/problems noted above.

### BRIEF DESCRIPTION OF THE DRAWINGS

The present invention will be described with reference to the accompanying drawings briefly described below.

FIG. 1 is a block diagram illustrating an example device in which several aspects of the present invention can be implemented.

FIG. 2 is a flow chart illustrating the manner in which a display controller is tested according to an aspect of the present invention.

FIGS. 3A-3G represent respective individual/single display screens illustrating the manner in which a display controller is conveniently and reliably tested in an embodiment of the present invention.

FIG. 4 is a block diagram illustrating the implementation details of a testing system in one embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention enables a tester (person) to specify multiple test cases of interest to test a display controller, and execute the test cases in a batch mode to cause the display controller to generate corresponding video output. Batch mode implies that test cases are executed one after the other, after the user has specified the desired test cases to be executed.

The tester is provided the ability to specify whether the displayed output (video output) corresponding to each executed test case is of desired quality or not. By relying on perceived quality of the video output by the tester, the reliability of test results is enhanced.

According to another aspect of the present invention, the tester is provided the ability to specify the input parameters for a test case in a single display screen, though a user (during normal use of a digital processing system containing the display controller) may have to navigate several screens to access/set the same input parameters. As the tester can provide the desired values corresponding to any input parameters of the test cases in a single screen, the overhead of setting up the test cases (prior to execution) is also reduced.

Several aspects of the invention are described below with reference to examples for illustration. However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

2. Digital Processing System

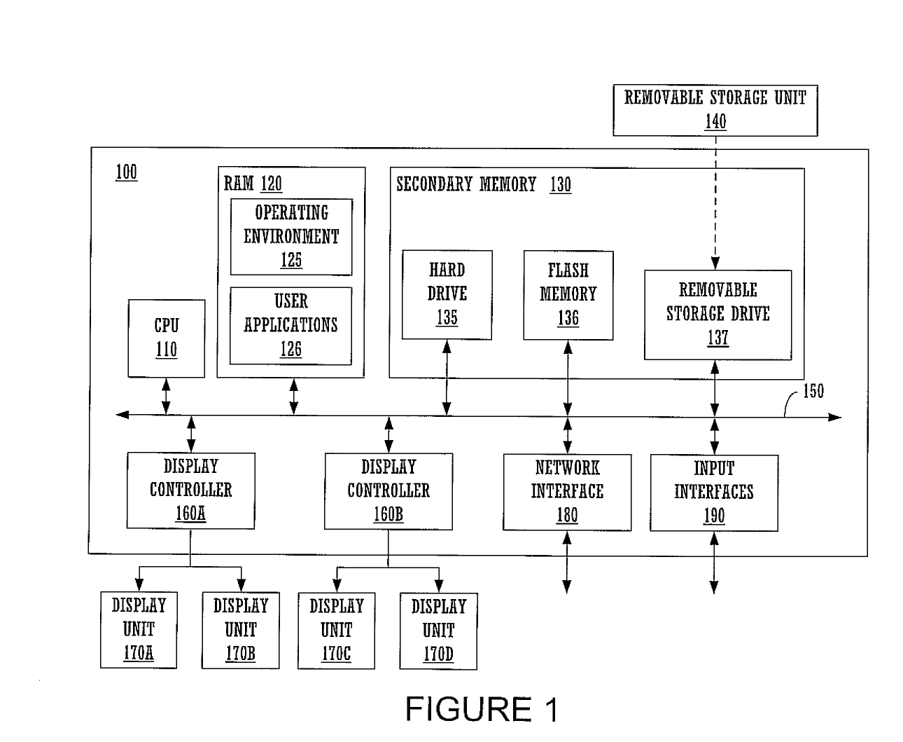

FIG. 1 is a block diagram illustrating the details of a digital processing system in which several aspects of the present invention are operative by execution of appropriate executable module instructions. Digital processing system 100 may contain one or more processors (such as a central processing unit (CPU) 110), random access memory (RAM) 120, secondary memory 130, display controllers 160A-160B (shown connected to display units 170A-170D), network interface 180, and input interfaces 190. All the components except display units 170A-170D may communicate with each other over communication path 150, which may contain several buses as is well known in the relevant arts. The components of FIG. 1 are described below in further detail.

CPU 110 may execute instructions stored in RAM 120 to provide several features of the present invention described in sections above. CPU 110 may contain multiple processing units, with each processing unit potentially being designed for a specific task, for example, to generate image data to be displayed. Alternatively, CPU 110 may contain only a single general-purpose processing unit. As another alternative, CPU 110 may be integrated with a display controller and provided as a single processor.

RAM 120 may receive instructions from secondary memory 130 using communication path 150. RAM 120 is shown containing software instructions constituting operating environment 125 and/or user applications 126 (such as client applications, media player applications, Web browser, application instances processing user requests, load balancer/management applications, RDBMS, etc.). In general, the operating environment contains operating system, device drivers, virtual machines, etc., which provide a (common) run time environment for execution of user applications. Embodiments of testing application described below may be implemented as a user application.

Secondary memory 130 may contain hard drive 135, flash memory 136, and removable storage drive 137. Secondary memory 130 may store the data and executable modules, which enable digital processing system 100 to provide several features in accordance with several aspects of the present invention.

Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drive 137 can read the data and instructions. Thus, removable storage unit 140 includes a computer readable (storage) medium having stored therein computer executable modules and/or data. However, the computer (or machine, in general) readable medium can be in other forms (e.g., non-removable, random access, etc.).

In this document, the term “computer program product” is used to generally refer to removable storage unit 140 or hard disk installed in hard drive 135. These computer program products are means for providing executable modules to digital processing system 100. CPU 110 may retrieve the instructions in the executable modules (via RAM 120), and execute the retrieved instructions to provide several features of the present invention described in further detail in sections below.

Network interface 180 provides connectivity to a network (e.g., using Internet Protocol), and may be used to communicate with other connected systems. Input interfaces 190 may correspond to components such as a keyboard and a pointing device (e.g., touch-pad, mouse) and may be used to provide various inputs, while testing display controllers also, as described in detail in sections below.

Each of display units 170A-170D contains a display screen to display the images defined by the display signals received from the corresponding display controller (and accordingly, a display unit may be viewed as being driven by the corresponding display controller). Display units 170A-170B are shown connected to display controller 160A and accordingly render the images represented by the display signals received from display controller 160A. Similarly, display units 170C-170D display the images received from display controller 160B.

Any combination of the display units can be operated for a common use (e.g., as a single extended display screen spanning the screens of the two display units). In the rest of the document, one (170A) of the display units is considered a primary display unit, which is used to display video images and the various user interfaces of several aspects of the present invention, described below.

Similarly, one (160A) of the display controllers is considered a primary display controller, and the same display controller is used to generate and control the display of video images whose quality has to be determined, as well as the various user interfaces of several aspects of the present invention.

Display controllers 160A-160B (operating individually or together) generate video signals (e.g., in RGB format) to the connected display units 170A-170D based on image data/instructions received from CPU 110. Video output/images are displayed on the corresponding display unit as a result. As noted above, it may be required to determine whether the display controllers provide video output of desired quality and accordingly tests may be performed according to various aspect of the present invention for such a determination. The background of such testing in one embodiment is described below first.

3. Testing Background

A display controller may be viewed as containing hardware components and executable modules. The hardware components may be collectively manufactured (or otherwise provided) as a video card or graphics card. In an embodiment, the executable modules contain (at least parts of) driver software (which is tested according to several aspects of the present invention). The driver software is typically provided as a part of the operating system as well. In general, the driver software and hardware together are responsible for various tasks such as generation of image frames, communication with other components (e.g., CPU 110), issuing of display signals to display unit/screen based on the generated image frames, etc.

The characteristics of the rendered images are determined by data referred to as display attributes. Examples of display attributes include resolution (indicating the number of pixels to be used in the display screen), refresh rate, luminosity indicating the brightness/contrast of the pixels, adjusting screen size and position, display rotation, hue, saturation, gamma, video color settings (gamma, dynamic range etc), video image settings (edge enhancement and noise reduction), 3D settings (anti aliasing, texture filtering, vertical sync, triple buffering, etc.), etc.

It may be appreciated that the above noted attributes affect the video output generated by all user applications and are thus usually configuration parameters to the respective display controllers. Aspects of the present invention enable test cases to test operation of setting of such attributes, as will be clear from the description below. Additional aspects enable inputs to be provided to applications (e.g., resizing parameters), which are then used internal to applications in generating corresponding video output.

In general, configuring display attributes entails associating a desired value to a specific display attribute. In a prior approach (also noted in the Background Section above), at least in case of parameters related to configuration of display controllers, a tester using a digital processing system manually configures display attributes for displaying on one or more display units (associated with the digital processing system) by using appropriate user interfaces (display as well as input ability using components such as keyboards and mouse) provided by the specific operating environment of the same digital processing system.

In general, all such configurations may impact the rendered video output and it may be desirable to perform several tests to confirm whether the video output is of desired quality. Various aspects of the present invention simplify such testing, as described below with examples.

4. Simplifying Determination of Display Controller Output Quality

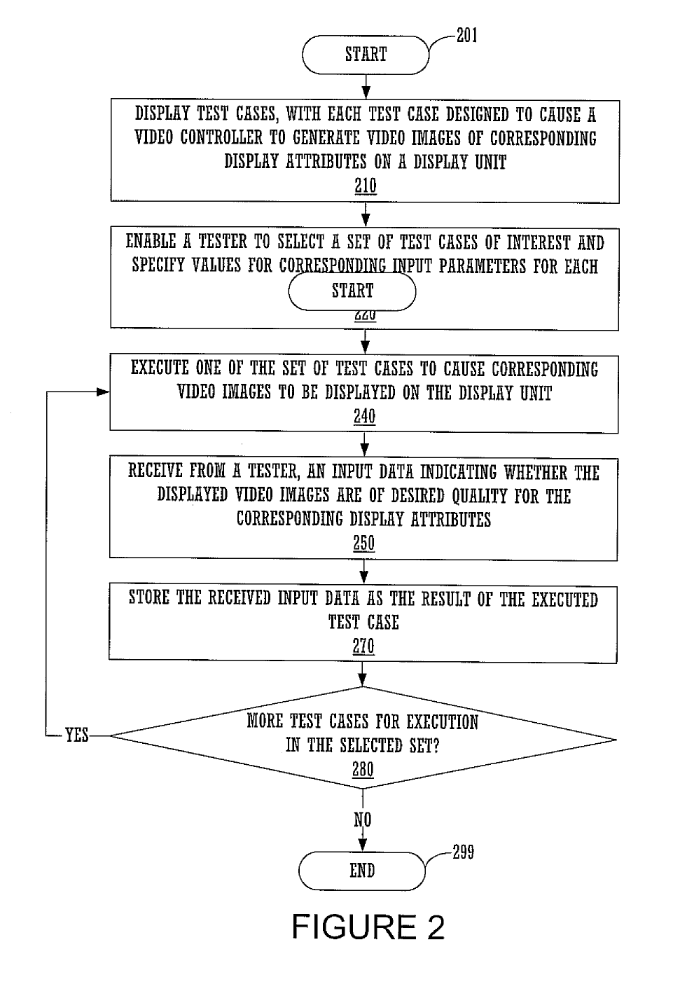

FIG. 2 is a flowchart illustrating the manner in which a tester may determine whether a display controller provides video output of desired quality. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, from which control immediately passes to step 210.

In step 210, CPU 110 displays various test cases available for testing the video output of a display controller, with each test case being designed to cause the display controller to generate video images of corresponding display attributes on a display unit. Each test case may be identified in the display by a corresponding label and/or description. The test cases may be displayed on a display screen provided in display unit 170A.

In step 220, CPU 110 enables a tester to select a set of test cases of interest for execution. The tester may make the selection based on any suitable interface, for example, using a keyboard and/or a pointer device connected to input interface 190. A complete or partial list of the selected set of test cases may be stored on RAM 120 to keep track of the test cases that are to be executed and the order in which they need to be executed.

CPU 110 may further enable the tester to specify values for corresponding input parameters of each test case, potentially in a single GUI screen. The set of input parameters for each test case include values for display attributes that determine how individual images are rendered. It may be appreciated that some of the display attributes affect only individual applications while some change the manner in which the display controller renders images in general (and thus can affect video output of all applications unless changed further). The tester may further specify execution parameters which indicate the manner in which the selected tests need to be performed (e.g., in which order, how many times specific/all tests are to be repeated, the delay duration between tests, etc.). The parameters thus specified may be stored in a configuration file in a memory in a pre-specified format.

In step 240, CPU 110 executes one of the test cases in the selected set of test cases to cause corresponding video images to be displayed on the display unit. In general, execution of a test case entails setting each display attribute to a corresponding value specified in step 220 and then causing the images to be rendered according to the set values. It may be appreciated that some of the display attributes (e.g., color depth) affect the content of image frames generated, while some (e.g., refresh rate) merely affect the rendering thereafter. CPU 110 may wait for input data from the tester after the execution of the test case.

In step 250, CPU 110 receives from a tester, input data indicating whether the displayed video images are of desired quality for the corresponding display attributes. In one embodiment, the tester is provided with two input options, to indicate whether the video output of the display controller is of desired quality or not, respectively. The tester visually inspects the video output on display unit 170A and chooses the appropriate option depending on whether the video output is perceived to be of desired quality or not. If the test case is repeated, the tester enters input data after every repetition.

In step 270, CPU 110 stores the input data received from the tester as the result/outcome for the executed test case (that is, whether the test case has passed or failed), in a memory. In one embodiment, the results of a test case are stored along with the corresponding input parameters and timing information (such as start and stop times of the test) in a same file in memory. The file may be stored, for example, in RAM 120, in secondary memory 130 or removable storage unit 140. At the end of step 270, all steps associated with the execution of the test case chosen in step 240 are complete.

In step 280, CPU 110 checks if there are more test cases remaining from the selected set of test cases to be executed. If there are more tests, control is transferred to step 240. Otherwise, control is transferred to step 299. The flowchart terminates in step 299.

It may be appreciated that the approach of above overcomes the disadvantage of the ‘Automated Testing’ Approach noted in the Background Section since the acceptability of display is based on human conclusion.

Similarly, the approach overcomes the disadvantage of the ‘Manual Testing’ approach in that the testing procedure is less tedious since the input parameters are provided in a batch mode (together before execution of the tests) and possibly reused. The tester is simply able to execute a sequence of tests while indicating the acceptability of the video output.

The approach described above is further illustrated below with the help of an example user interface.

5. Example User Interface

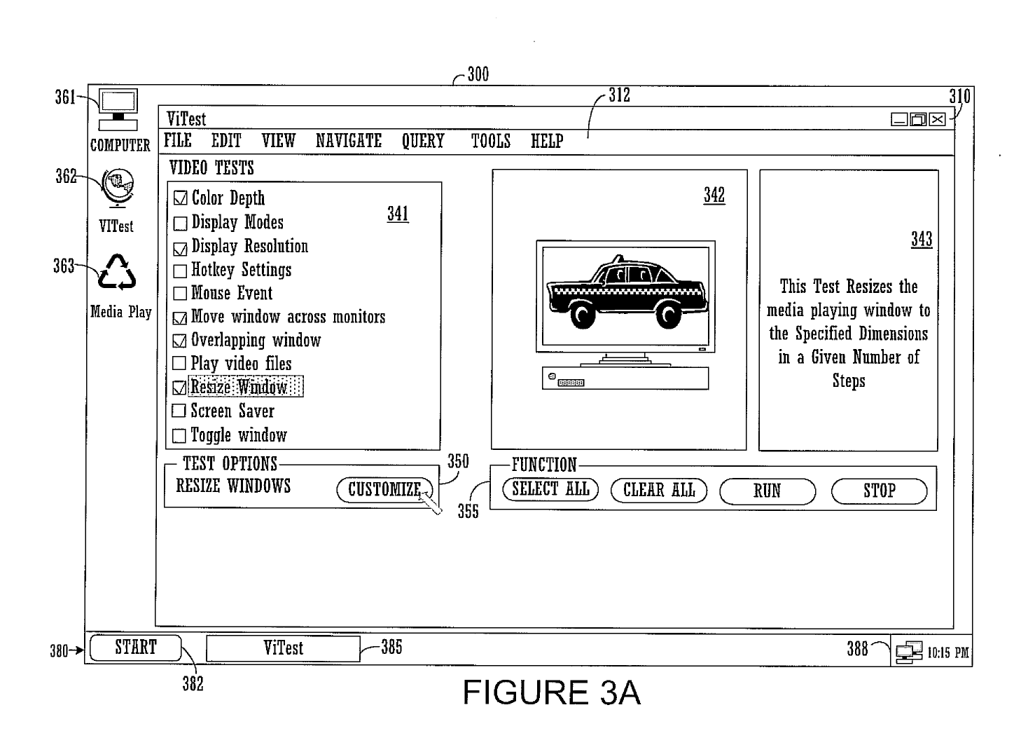

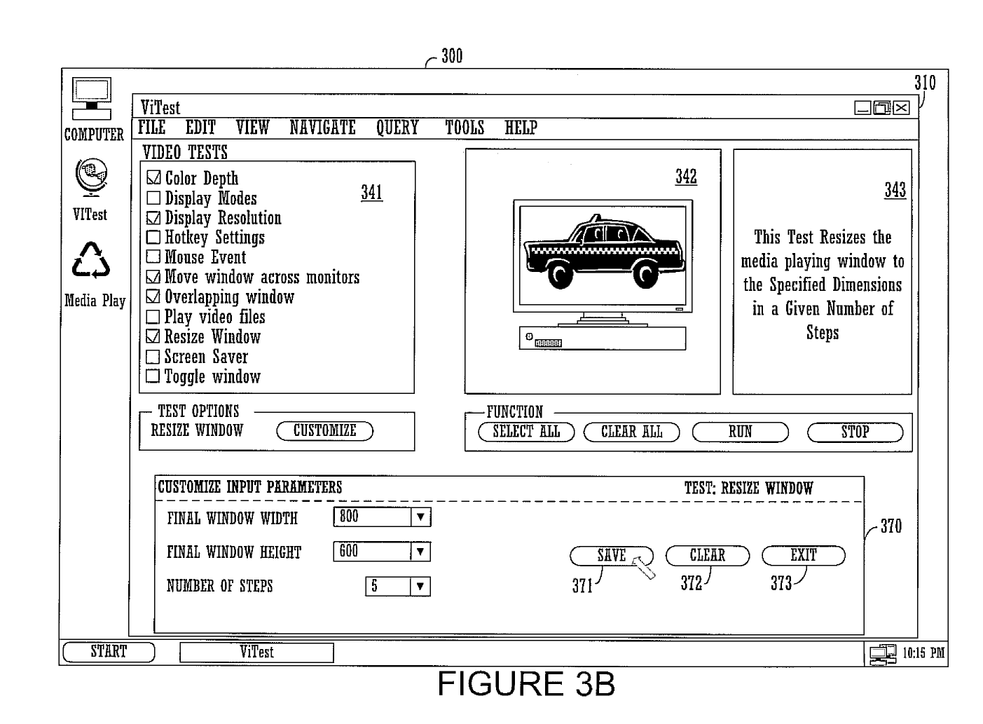

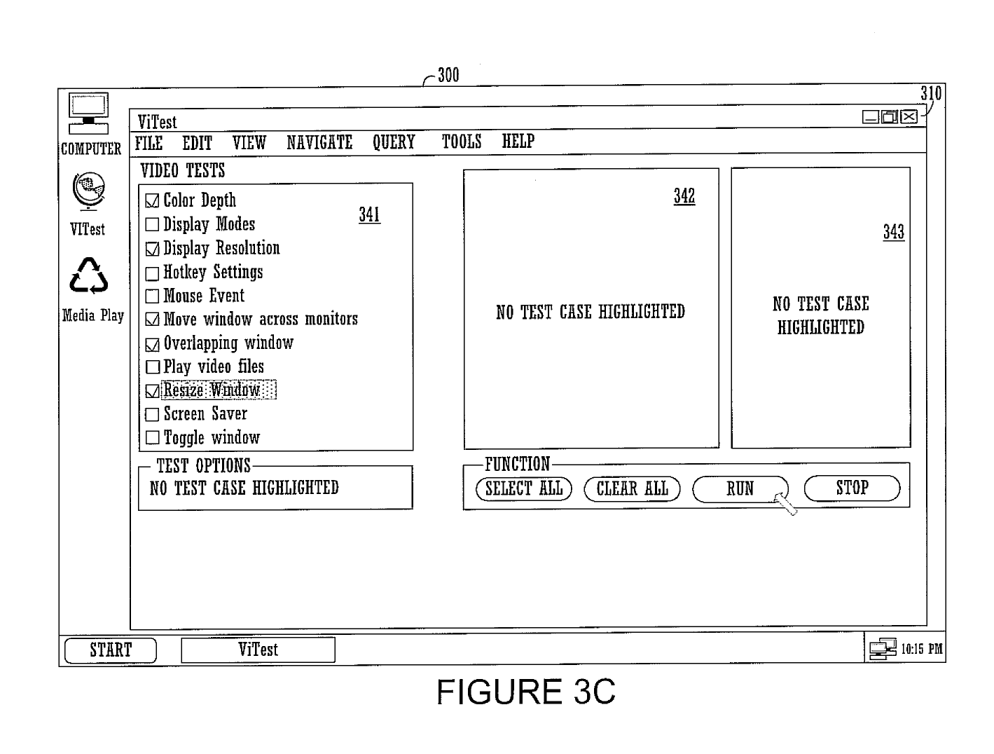

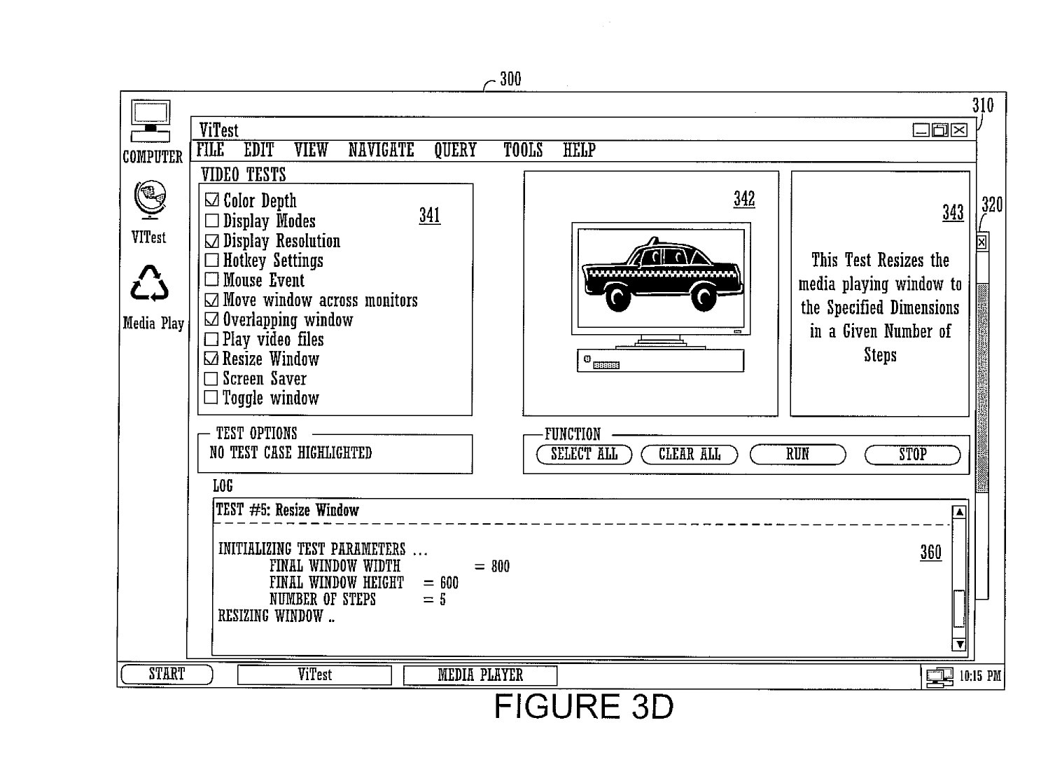

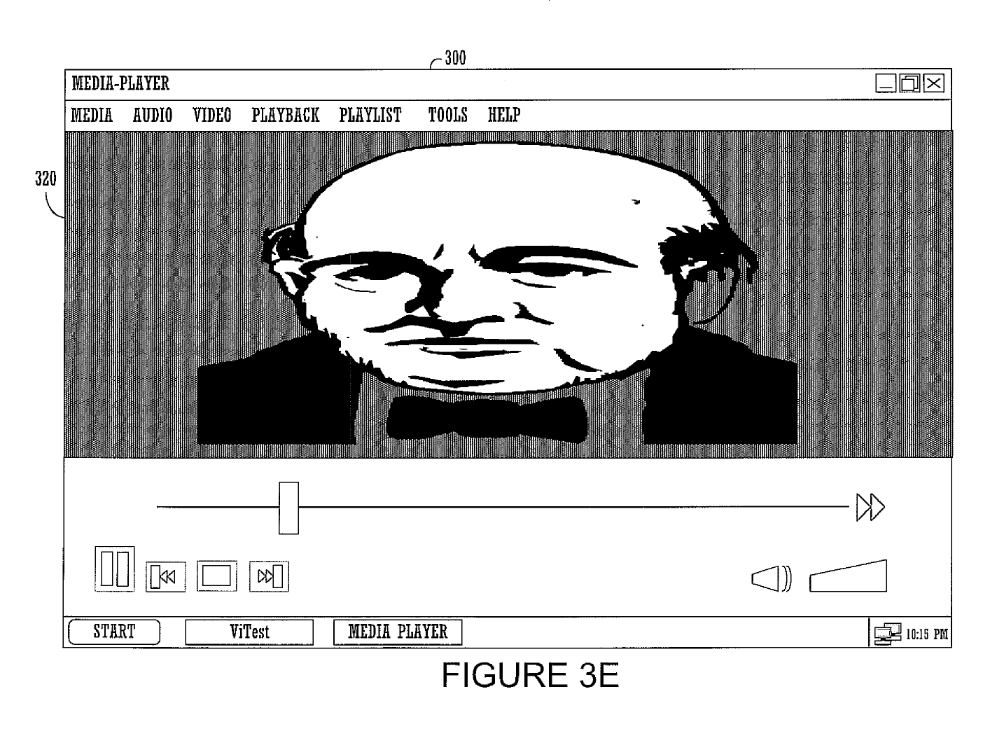

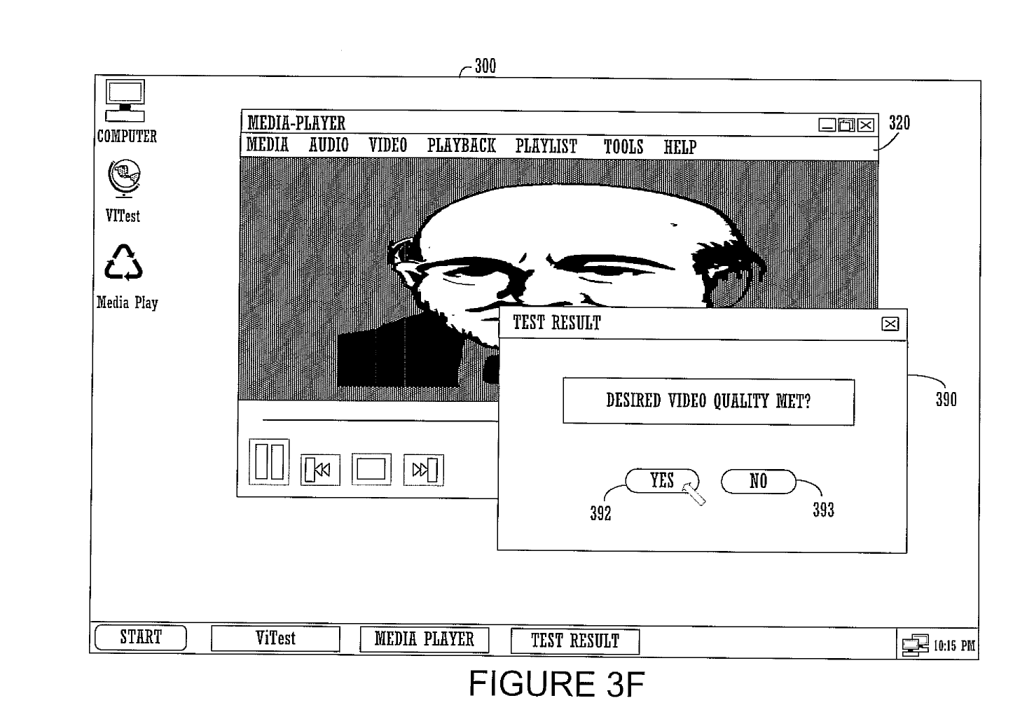

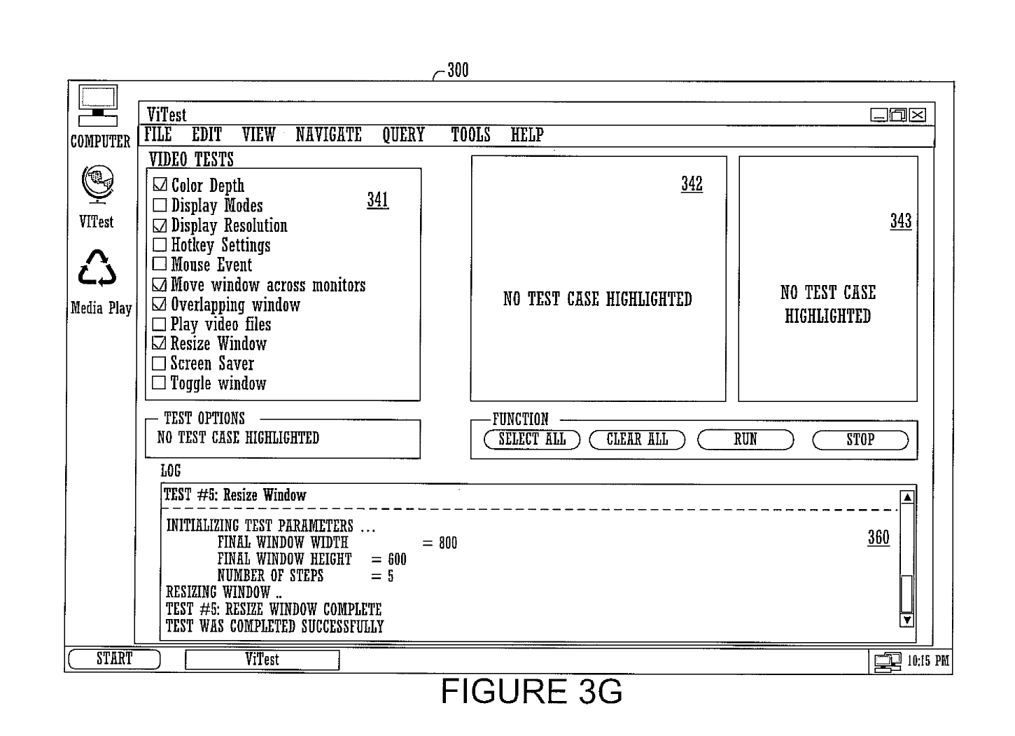

FIGS. 3A-3G together depict an example user interface using which a tester may determine whether the video output of display controller 160A is of desired quality or not. The user interface is provided in the context of Windows XP operating system, available from Microsoft Corporation. Desktop 300 represents a portion of a GUI screen provided by an operating system executing in digital processing system 100. Desktop 300 may be displayed on one or more of display units 170A-170D.

Desktop 300 contains taskbar 380, which is an interface element provided by the operating system to enable users to initialize and monitor applications (and the corresponding windows). Taskbar 380 is shown containing start button 382, application buttons 385 and system tray 388. Start button 382 enables users to access and initialize desired applications, to access new or recently accessed documents and/or to access the settings governing the operation of the system etc. System tray 388 (also termed as notification area) displays graphical icons and/or text which convey status information related to executing applications.

Application button 385 enables a user to switch to (away from) a corresponding window provided by an application. On selection of an application button, the corresponding window (termed the active window) is displayed on top of all other windows thereby enabling the user to interact with the corresponding application. Application buttons corresponding to active windows are shown with bold text. In the present embodiment, application button 385 represents windows 310 (referred to as “ViTest”).

Desktop 300 also contains icons 361-363, which are graphical representations of the applications accessible in desktop 300. The execution of the corresponding applications may be initiated by a user by selecting the appropriate one of the icons 361-363. For example, a tester may select (by double clicking) icon 363 to cause an instance of a media player application to be executed and icon 362 to cause the tests to be performed according to several aspects of the present invention.

In general, an operating system enables multiple applications to be executed in a system while providing (shared) access to the various hardware components of the system in a known way. The operating system (for example, Windows XP operating system noted above or Linux operating system) also enables each of the applications to interact with a user by providing a corresponding user interface commonly termed a window in the execution state of the applications.

With specific reference to FIG. 3A, window 310 depicts a user interface using which step 220 is performed. Menu 312 enables a tester to access/perform various actions provided by window 310. Selection area 341 provides a list of test cases available for testing the video output of the display controller and a selection option which allows a tester to select a set of test cases of interest, for execution.

In the embodiment shown, selection is achieved by means of a check box next to each test case, wherein checking the check box (through a mouse, for example) corresponds to selection of the test case. Clicking on the name of a test case in selection area 341 highlights the name of the test case. Display area 342 displays a picture/animation/video representative of the highlighted test case, while display area 343 displays a brief description of the highlighted test case.

Function area 355 allows a tester to begin execution of a test case (using the “Run” button) and stop execution of test cases midway (that is, stopping the execution of all test cases after completion of the test case presently being executed, using the “stop” button). Function area 355 also allows the tester to include or remove all available test cases shown in display area 341, using the “Select all” and “Clear all” buttons respectively.

Test options area 350 allows a tester to configure the input parameters for a highlighted test case. In the embodiment shown, the input parameters of a highlighted test case can be configured by clicking on the “customize” button. A new user interface element may be displayed in window 310 to allow the tester to customize the input parameters.

In FIG. 3A, five test cases (“Color Depth”, “Display Resolution”, “Move window across monitors”, “Overlapping window”, and “Resize Window”) have been shown selected by the tester for execution. Each test case is intended to test the corresponding display feature, as is clear from the label/name of the test case. It may be appreciated that some test cases verify display attributes, some application attributes and some both.

The test case named “Resize Window” (hereafter, “resize-window test case”) is shown highlighted. Resize-window test case entails the determination of quality of video output of display controller 160A when a window displaying the video output is resized. For example, a media player application window may be resized when video output of display controller 160A is being displayed in the window. The input parameters for the test case include the final width and height of the resized window, and the number of steps for resizing.

The tester is shown clicking on customize button in test options area 350 in order to set values for the input parameters for resize-window test case. When clicked, the window of FIG. 3B is displayed.

FIG. 3B depicts aspects of desktop 300 which allow the customization of input parameters for the resize-window test case (and any highlighted test case in general). In general, customization area 370 displays all input parameters necessary for the highlighted test case and provides user interface elements (such as pull-down boxes, text input areas, etc.) next to each input parameter, that enable the tester to provide desired values for the corresponding input parameters.

In the embodiment shown, customization area 350 is shown providing three options to the tester—“Save” button 371 allows the tester to save the values presently associated with the input parameters, “Clear” button 372 allows the tester to clear the values presently associated with the input parameters and “Exit” button 373 allows the tester to exit customization area 370.

When the ‘save’ option is used, the values provided for the test are stored in a configuration file (provided on secondary storage 130). The parameter values can be retrieved and provided as inputs for subsequent tests (in later batches). In other words, the testers may conveniently reuse previously provided input values for specific test cases, if so desired.

In addition, the configuration file can be transported (e.g., using a file transfer on a network or by copying onto a floppy disk type transportable medium) to another digital processing system to conduct the same tests (based on the same values). Once the file is copied, the new digital processing system may be used by a tester to perform the tests specified in the configuration file. Thus, in a large organization testing several display controllers, a configuration file can be standardized and then used by several testers to test respective controllers in parallel.

For the resize-window test case shown highlighted, values have been provided by the tester for the input parameters “Final Window Height” (set to 800), “Final Window Width” (set to 600) and “Number of Steps” (set to 5). The tester is shown selecting the “Save” button 371 in order to save the values currently associated with the input parameters, and the screen of FIG. 3C may be displayed.

FIG. 3C depicts aspects of desktop 300 which allow the tester to begin execution of the set of test cases selected. The tester is shown selecting the “Run” option in function area 355, in order to begin execution of the five selected test cases in batch mode. As will be clear from the description below, batch mode is distinguished from one-at-a-time mode in which each test case is executed immediately after selection of a single test by the tester. Thus, in the one-at-a-time mode, the tester needs to wait for completion of a test case before specifying the next test case for execution.

FIG. 3D depicts aspects of desktop 300 during the execution of one of the selected test cases. Test cases presently being executed and those to be executed next are shown with the check box next to the test name being checked. In the figure, execution of four test cases has been completed, while the execution of the fifth test case (resize-window test case) has begun. This is shown in test log display area 360.

Test log display area 360 provides details of the status of execution of each test case. In the example shown, execution of the resize-window test case has begun and input parameters for the test case have been initialized.

A media player window 320 is accordingly opened (in background) in order to display the video output of display controller 160A on display unit 170A. Resizing of window 320 is shown to be starting, as indicated in test log display area 360 of FIG. 3D. Window 310 is then automatically sent to the background, causing media player window 320 to be displayed in the foreground, as depicted in FIG. 3E.

FIG. 3E depicts the initial size of media player window 320 at the beginning of the resize window test case. Window 310 is shown minimized, while media player window 320 is shown starting fully maximized at the beginning of the test case. Alternative embodiments of the present invention may have a resize-window test case where the initial dimensions of window 320 are specified as input parameters. Media player window 320 is shown playing video output of display controller 160A. The tester visually inspects the quality of video displayed in window 320.

FIG. 3F depicts desktop 300 at the final step of resize-window test case (with the display corresponding to 4 intermediate resize steps not shown for conciseness). Media player window 320 is shown resized as specified by the input parameters. The tester is presented with a window 390, with which the tester can specify the result of the corresponding test case whose execution has been completed.

A prompt message 391 indicates the input expected from the tester for the test case just executed. In the embodiment shown, the tester is presented with two options for the test result—a “Yes” button 392 for indicating that the video output was of desired quality and a “No” button 393 for indicating that the video output was not of desired quality.

The tester selects an option by clicking on the corresponding button. As an example, the tester is shown clicking on button 392, indicating that the video output displayed while resizing the display window, had the desired quality. Alternative embodiments may enable a tester to provide score (e.g., on a 1 to 10 scale) indicating the satisfaction level. Irrespective, the indicated result is stored associated with the executed test case. The input parameters of the test case also may be stored in association, such that the tester can see the input parameters also along with the result, when the results of all the tests are reviewed after batch processing of the test cases.

FIG. 3G depicts desktop 300 upon completion of test case execution after the tester enters the result of the test case. In the present example, the resize-window test case is shown to be ‘successful’ in the test log display area 360. The tester may check/analyze the input parameters and results of all executed test cases by display information rendered in test log display area 360 during execution of the test case.

In addition or in the alternative, a suitable interface may be provided for a tester to inspect the test log file stored in a secondary (non-volatile) memory. As described below, the test result (yes or no in the above example) and the values of the input parameters are stored associated with the test case related information such that the tester can easily view/appreciate the consolidated results of execution of the test cases.

The tester may again select a different set of desired test cases for execution as a next batch in batch mode. If the input parameters for one or more test cases in the set have already been specified by the tester (provided for the same test cases executed in previous batch and stored in a configuration file) and need not be changed, then the tester need not specify them again. The input parameters are automatically retrieved from the configuration file while executing the corresponding test case.

Using the example user interface described in FIGS. 3A-3G, a tester needs to provide input data for all test cases in a single user interface window instead of navigating several GUI screens (as required by the manual testing prior approach described in the Background Section). In other words, users (who are not testers) may be provided a set of windows using which they may be able to set some of the attributes (e.g., display resolution, refresh rate, etc.) at the corresponding user interface screens. Navigating to these different user interface screens would consume substantial number of mouse-clicks and thus time/effort. In sharp contrast, as may be readily observed from FIG. 3G, the tester is provided the ability to input desired values for display attributes in a single (or a smaller set of screen compared to the user interfaces available to regular non-tester users) screen.

In addition, the result of a test case is determined by a human tester after visual inspection of video output, so that acceptable video output is correctly identified as having desired quality (unlike the automated testing prior approach, as described in the Background Section).

It may thus be appreciated that by using the user interface described above, testing the quality of the video output of display controller 160A is made simple. The implementation of several aspects of the present invention which enable this simplification is described below with reference to an example embodiment.

6. Implementation

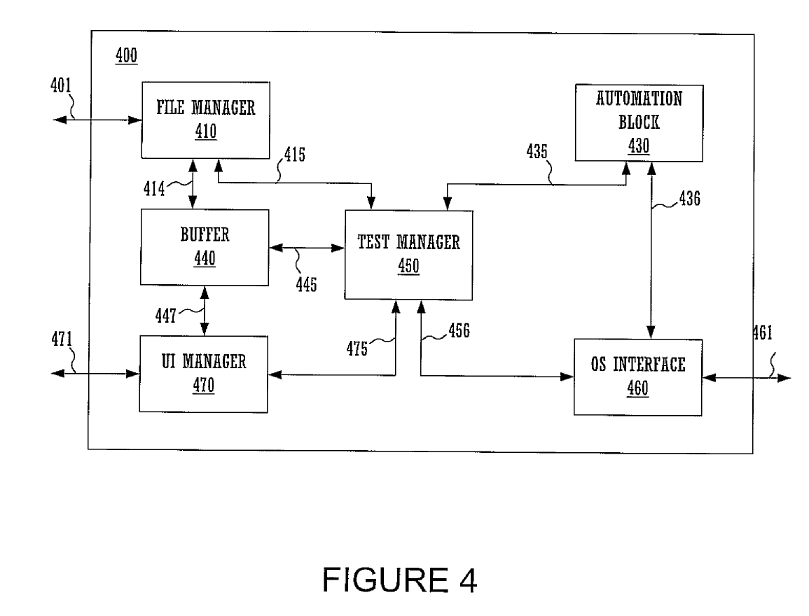

FIG. 4 is a block diagram illustrating the implementation details of an embodiment of the present invention. System 400 is shown containing file manager 410, automation block 430, buffer 440, test managers block 450, OS interface 460 and UI manager 470. In an embodiment, each of the blocks is implemented as software instructions (forming corresponding executable modules) executed by appropriate hardware elements. However, each block can be implemented in a desired combination of hardware, software and firmware.

The blocks, their interfaces, and operation are merely illustrative. However, various features can be implemented in other environments also without departing from the scope and spirit of various aspects of the present invention, as will be apparent to one skilled in the relevant arts by reading the disclosure provided herein.

Buffer 440 may be supported with RAM 120 and be used by several components of system 400 for temporary storage of data. For example, the data specified by tester in the user interface screens of FIGS. 3A-3C may be stored in buffer 440, before being stored in the corresponding configuration files and/or being provided to test manager for execution of specified test cases. Similarly, data regarding the execution status and outcome of test cases (which may be sent to a test log file) may be stored in buffer 440 till the completion of execution of the corresponding test case. The data in the buffer is then eventually stored in the corresponding file via file manager 410.

UI manager 470 enables the tester to indicate various test cases of interest and configure the desired values for each display parameter pertinent to each test case of interest, for example, as described above with respect to FIGS. 3A-3C. Buffer 440 may be used to store the various attribute-value pairs specified and the test cases selected. When a tester selects Run, UI manager 470 may pass control to test manager 450, for execution of each of the selected tests. Once the execution of tests is completed, control may be returned to UI manager 470, which enables the tester to view various logs/results and/or execute additional test cases again, as desired.

File manager 410 enables various data to be stored in and retrieved from corresponding files provided on a non-volatile memory. In particular, file manager 410 receives from UI manager 470, the input parameters for a test case, and stores (in non-volatile memory 135) the received values into a configuration file. The values can be used for execution of the same test case and accordingly the values may again be retrieved and provided to test manager 450 when a corresponding test case is sought to be later executed.

File manager 410 receives from test manager 450 messages pertaining to the status of execution of a test case (that may be displayed in test log display area 360), and stores the received messages in a test log file (on non-volatile memory 135). Similarly, the results of execution entered by a tester (e.g., as in FIG. 3F) may be received and stored in the test log file.

OS interface 460 provides various system calls to interface with the display controllers 160A/160B, input interface 190 (containing mouse), etc. Thus, the system calls may be used to set various display attributes to desired values, to interface with mouse, etc.

Automation block 430 contains utility classes (with corresponding methods) for performing several commonly occurring tasks. These methods are invoked by test manager for the corresponding utility. The methods may in turn invoke the appropriate system calls.

Test managers block 450 executes each test case based on the information provided by the tester and/or pre-configured values. In an embodiment, each test case (of the available set of test cases) has an associated test manager module, which is selected and executed (instance instantiated) for the corresponding test case.

The test manager instance then retrieves the values for the corresponding display attributes and executes the test case with the value-attribute pairs. Execution may entail calling methods available in automation block 430 and making system calls available through OS interface 460. For example, with respect to resize-window test case, the test manager instance opens an application window with specific start dimensions using a system call available through OS interface 460. The test manager instance then calls a method available in automation block 430 which resizes an opened window to specific end dimensions in a specified number of steps. The test manager instance obtains the input parameters required for the called method from the configuration file corresponding to the test case being executed (resize-window in this case). It should be appreciated that the implementation of such methods for specific test cases will be apparent to one skilled in the relevant arts.

Alternatively, when the execution of a test case entails simpler logic (e.g., merely setting a register to a specific value and letting the display continue), the test manager may only invoke the corresponding system call directly through OS interface 460 (to set the display attribute to the desired value). For example, in case of test cases (Color Depth, Display Modes, Display Resolution, Hot Key Settings of FIG. 3B), the tester may provide appropriate input values, which are stored in the appropriate registers (not shown) controlling the operation of the display controller. Once the values are stored, the images are rendered based on the stored values, as is well known in the relevant arts.

Thus, after executing a test case, the test manager (instance) may query the tester whether the quality standard is met (e.g., as in FIG. 3F), and pass the response to file manager 410 for storing. It should be appreciated that the wait time between tests, etc., can also be set using different screen of the user interface. Similarly, the test manager may generate various information messages that are also stored in the log file, during execution of the tests.

Test managers block 450 may contain addition logic to check whether additional test cases (step 280) are present for execution and instantiate the appropriate test manager.

It may be appreciated that system 400 allows the execution of a set of test cases for testing video output of display controller 160A by means of a single window 310 displayed to a tester.

7. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A machine readable medium carrying one or more sequences of instructions causing a digital processing system to facilitate the testing of a display controller contained in said digital processing system, wherein execution of said one or more sequences of instructions by one or more processors contained in said digital processing system causes said digital processing system to perform the actions of:
displaying a set of test cases designed to test said display controller;
enabling a tester to select a plurality of test cases and to provide a corresponding set of input parameters required for execution of each of said plurality of test cases, said plurality of test cases being contained in said set of test cases;
executing said plurality of test cases in a batch mode to cause video images corresponding to each test case to be displayed on a display screen, wherein said executing is performed after said tester selects said plurality of test cases; and
receiving a respective result input from said tester indicating whether the video output generated by said display controller for each of said plurality of test cases is of acceptable quality.

2. The machine readable medium of claim 1, further comprising instructions for storing said respective result input associated with the corresponding test case.

3. The machine readable medium of claim 2, further comprising instructions for:
storing said sets of input parameters in a configuration file stored on a non-volatile memory after said tester provides the input parameters;
retrieving said sets of input parameters for executing the corresponding test cases.

4. The machine readable medium of claim 3, further comprising instructions for:
providing a plurality of screens to a tester to specify values for a plurality of display attributes, wherein said plurality of display attributes are used in a first test case comprised in said set of test cases,
wherein said enabling provides a single screen to said tester to provide values for all of said plurality of display attributes.

5. The machine readable medium of claim 3, wherein said plurality of test cases are executed in a first batch in said batch mode, said machine readable medium further comprising instructions for:
executing a second test case in a second batch in said batch mode, said second test case being contained in said plurality of test cases executed in said first batch and said second batch being executed after said first batch,
wherein the input parameters for said second test case are provided only prior to execution of said first batch and are provided as inputs to said second test case in said second batch by retrieving the input parameters from said configuration file on said non-volatile memory.

6. The machine readable medium of claim 3, wherein said plurality of test cases comprises a resizing test case, wherein said input parameters comprise a final window width, a final window height and a number of steps, further comprising instructions for:
displaying first an initial window of a start width and a start height, and then a sequence of windows each with successive smaller size in said number of steps until a last window in said sequence is displayed with said final window width and said final window height.

7. The machine readable medium of claim 3, wherein said set of input parameters for a first test case specify attributes affecting only a corresponding application, for a second test case specify attributes affecting said display controller and for a third test case specify attributes affecting both the application and the display controller.

8. A digital processing system comprising:
a processor;
a random access memory (RAM);
a display controller to generate a video output for rendering on a display unit; and
a machine readable medium to provide a set of instructions which are designed to be retrieved into said RAM and executed by said processor, wherein execution of said set of instructions by said processor causes said digital processing system to perform the actions of:
displaying a set of test cases designed to test said display controller;
enabling a tester to select a plurality of test cases and to provide a corresponding set of input parameters required for execution of each of said plurality of test cases, said plurality of test cases being contained in said set of test cases;
executing said plurality of test cases in a batch mode to cause video images corresponding to each test case to be displayed on a display screen, wherein said executing is performed after said tester selects said plurality of test cases; and
receiving a respective result input from said tester indicating whether the video output generated by said display controller for each of said plurality of test cases is of acceptable quality.

9. The digital processing system of claim 8, wherein said machine readable medium further comprises instructions for storing said respective result input associated with the corresponding test case.

10. The digital processing system of claim 9, wherein said machine readable medium further comprises instructions for:
storing said sets of input parameters in a configuration file stored on a non-volatile memory after said tester provides the input parameters; and
retrieving said sets of input parameters for executing the corresponding test cases.

11. The digital processing system of claim 10, wherein said machine readable medium further comprises instructions for:
providing a plurality of screens to a tester to specify values for a plurality of display attributes, wherein said plurality of display attributes are used in a first test case comprised in said set of test cases,
wherein said enabling provides a single screen to said tester to provide values for all of said plurality of display attributes.

12. The digital processing system of claim 10, wherein said plurality of test cases are executed in a first batch in said batch mode, said machine readable medium further comprising instructions for:
executing a second test case in a second batch in said batch mode, said second test case being contained in said plurality of test cases executed in said first batch and said second batch being executed after said first batch,
wherein the input parameters for said second test case are provided only prior to execution of said first batch and are provided as inputs to said second test case in said second batch by retrieving the input parameters from said configuration file on said non-volatile memory.

13. The digital processing system of claim 10, wherein said plurality of test cases comprises a resizing test case, wherein said input parameters comprise a final window width, a final window height and a number of steps, said machine readable medium further comprising instructions for:
displaying first an initial window of a start width and a start height, and then a sequence of windows each with successive smaller size in said number of steps until a last window in said sequence is displayed with said final window width and said final window height.

14. The digital processing system of claim 10, wherein said set of input parameters for a first test case specify attributes affecting only a corresponding application, and for a second test case specify attributes affecting said display controller.

15. A method of testing a display controller provided in a digital processing system, said method comprising:
displaying a set of test cases designed to test said display controller;
enabling a tester to select a plurality of test cases and to provide a corresponding set of input parameters required for execution of each of said plurality of test cases, said plurality of test cases being contained in said set of test cases;
executing said plurality of test cases in a batch mode to cause video images corresponding to each test case to be displayed on a display screen, wherein said executing is performed after said tester selects said plurality of test cases; and
receiving a respective result input from said tester indicating whether the video output generated by said display controller for each of said plurality of test cases is of acceptable quality.

16. The method of claim 15, wherein said method further comprises storing said respective result input with the corresponding test case.

17. The method of claim 16, wherein said method further comprises:
storing said sets of input parameters in a configuration file stored on a non-volatile memory after said tester provides the input parameters;
retrieving said sets of input parameters for executing the corresponding test cases.

18. The method of claim 17, further comprising:
transporting said configuration file to another digital processing system and using said configuration file to execute said plurality of test cases with said sets of input parameters.

19. The method of claim 18, said method further comprising:
providing a plurality of screens to a tester to specify values for a plurality of display attributes, wherein said plurality of display attributes are used in a first test case comprised in said set of test cases,
wherein said enabling provides a single screen to said tester to provide values for all of said plurality of display attributes.

20. The method of claim 18, wherein said plurality of test cases are executed in a first batch in said batch mode, said method further comprising:
executing a second test case in a second batch in said batch mode, said second test case being contained in said plurality of test cases executed in said first batch and said second batch being executed after said first batch,
wherein the input parameters for said second test case are provided only prior to execution of said first batch and are provided as inputs to said second test case in said second batch by retrieving the input parameters from said configuration file on said non-volatile memory.
